(19) United States
(12) Patent Application Publication
(10) Pub. No.: US 2012/0224263 A1
(43) Pub. Date: Sep. 6, 2012

(54) Optical Systems Utilizing Diffraction Gratings To Remove Undesirable Light From A Field Of View

(75) Inventor: Dennis J. Gallagher, Boulder, CO (US)

(73) Assignee: OmniVision Technologies, Inc.

(21) Appl. No.: 13/039,258

(22) Filed: Mar. 2, 2011

(51) Int. Cl. G02B 5/18

(52) U.S. Cl. 359/570

(57) ABSTRACT

An optical system has a lens assembly for imaging an object. The lens assembly includes a lens wherein at least a portion of a peripheral part of the lens includes a diffraction grating arranged to divert light arriving on the peripheral part of the lens from an object. The diffraction grating diverts the light away from a focal region, where a central part of the lens focuses light arriving on the central part of the lens from the object, into an image of the object.

### TECHNICAL FIELD

This disclosure relates generally to optical lenses, and in particular but not exclusively, relates to optical lenses that include one or several diffraction gratings.

### BACKGROUND

A diffraction grating is an optical device with periodic structures such as grooves. It splits and diffracts an incident light beam into its constituent wavelengths and into several diffracted light beams traveling in different directions. Groove spacing density, depth and profile are some of the factors that affect the spectral range, efficiency, resolution and performance of the diffraction grating. For example, the spacing between grooves, together with the wavelength of the incident light, affects in part the directions of the diffracted light after it leaves the grating.

Diffraction gratings include reflection gratings and transmission gratings. A reflection type grating reflects incident light, thereby producing diffracted light on the same side of the grating surface as the incident light. In order to reflect an incident light, a reflection grating surface may have a reflective property applied through a reflective coating. A transmission type grating permits incident light to transmit through the grating surface, thereby producing diffracted light on the opposite side of the grating surface from the incident light, also known herein as behind the grating. In order to permit more incident light to transmit through the grating surface, a transmission grating surface may have an antireflective property by means such as an antireflective coating.

Diffraction gratings may be ruled or holographic. A ruled grating may be produced by a ruling engine that cuts grooves into a grating substrate. A holographic grating may be produced by intersecting light beams that produce a holographic interference pattern on a grating substrate.

### SUMMARY

In an embodiment, an optical system has a lens assembly for imaging an object. The lens assembly includes a lens wherein at least a portion of a peripheral part of the lens includes a diffraction grating arranged to divert light arriving on the peripheral part of the lens from an object. The diffraction grating diverts the light away from a focal region, where a central part of the lens focuses light arriving on the central part of the lens from the object, into an image of the object.

### BRIEF DESCRIPTION OF THE DRAWINGS

Non-limiting and non-exhaustive embodiments of the invention are described with reference to the following FIGs., wherein like reference numerals refer to like parts throughout the various views unless otherwise specified.

FIG. 1A is a cross sectional view of a diffraction grating surface showing an in-plane, single order, transmission type diffraction as known in the art.

FIG. 1B is a cross sectional view of a surface without diffraction grating showing a refraction as known in the art.

FIG. 1C is a perspective view of a diffraction grating surface showing incident light that will result in a conical, transmission type diffraction, as known in the art.

FIG. 1D is a cross sectional view of a diffraction grating surface showing an in-plane, multiple order, transmission type diffraction, as known in the art.

FIG. 2 is a cross sectional view of a diffraction grating surface showing a blazed angle that effectively results in all the diffracted light in a single order, according to an embodiment.

FIG. 3A is a schematic cross sectional view of a wafer level camera, according to an embodiment.

FIG. 3B is a perspective view of a lens yard including a diffraction grating that diffracts stray light away from an underlying focal area, according to an embodiment.

FIG. 3C a perspective view of a prior art lens yard that does not include a diffraction grating, thereby allowing stray light to reach a focal area, as common in the art.

FIG. 4A is a perspective view of a lens assembly showing a diffraction grating on a lens yard and an underlying optical baffle structure, according to an embodiment.

FIG. 4B is a cross sectional view of a lens assembly showing a diffraction grating on a lens yard diffracting stray light away from a focal area and into an optical baffle structure, according to an embodiment.

FIG. 4C is a cross sectional view of a lens assembly without a diffraction grating on the lens yard, showing stray light being refracted into a focal area.

FIG. 4D is a cross sectional view of the optical baffle of FIG. 4A.

FIG. 5 is a cross sectional view showing several light beams producing an interference pattern on a grating surface, thereby producing a holographic grating, according to an embodiment.

FIG. 6A is a perspective view of a rectangular shaped grating, according to an embodiment.

FIG. 6B is a perspective view of a blazed triangular shaped grating, according to an embodiment.

FIG. 6C is a perspective view of a holographic sinusoidal shaped grating, according to an embodiment.

FIG. 6D is a perspective view of a blazed holographic grating with a triangular profile having relatively smooth edges, according to an embodiment.

FIG. 7A is a perspective view of a grating substrate topped with a photoresist layer, according to an embodiment.

FIG. 7B is a perspective view of laser beams exerting effects of holographic exposure and developing on the photoresist layer of FIG. 7A.

FIG. 7C is a perspective view of reactive ion beams etching a pattern into the holographically exposed and developed resist layer of FIG. 7B, thereby producing a blazed holographic grating.

FIG. 8A is a perspective view showing a replica grating matching a master grating during a replicating process, according to an embodiment.

FIG. 8B is a perspective view showing a replica grating after parting from the master grating,

FIG. 9A is a cross sectional view of a diffraction grating surface showing an in-plane, single order, reflection type diffraction, according to an embodiment.

FIG. 9B is a cross sectional view of a surface without diffraction grating showing a reflection.

FIG. 10A is a cross sectional view of a custom milling tool that includes a milling tip with a blazing angle, according to an embodiment.

FIGS. 10B, 10C, and 10D are cross sectional profiles of several milled gratings, according to embodiments.

### DETAILED DESCRIPTION OF THE DRAWINGS

In the following description, numerous details are set forth to provide a thorough understanding of the present invention. In some instances, well-known structures, materials, or operations are not shown or described in detail to avoid obscuring other aspects of the embodiments.

Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

A diffraction grating is utilized to diffract undesirable light away from a focal area, such as photosensors of an image sensing array. This technology is applicable to the art of wafer level optics. In one class of embodiments, a lens of a wafer level integration optical assembly has a diffraction grating at its outer rim, i.e., the lens yard. Stray light that reaches the photosensor array of the image sensor is undesirable because it can cause lens flare, which can decrease image contrast, producing washout, and produce visible artifacts in the resulting image. Incoming stray light that reaches the grated rim is diffracted away, thereby preventing the stray light from reaching the lens's focal area, and thereby preventing the stray light from reaching the photosensors of the image sensing array. As a result, flaring is reduced and imaging quality is improved.

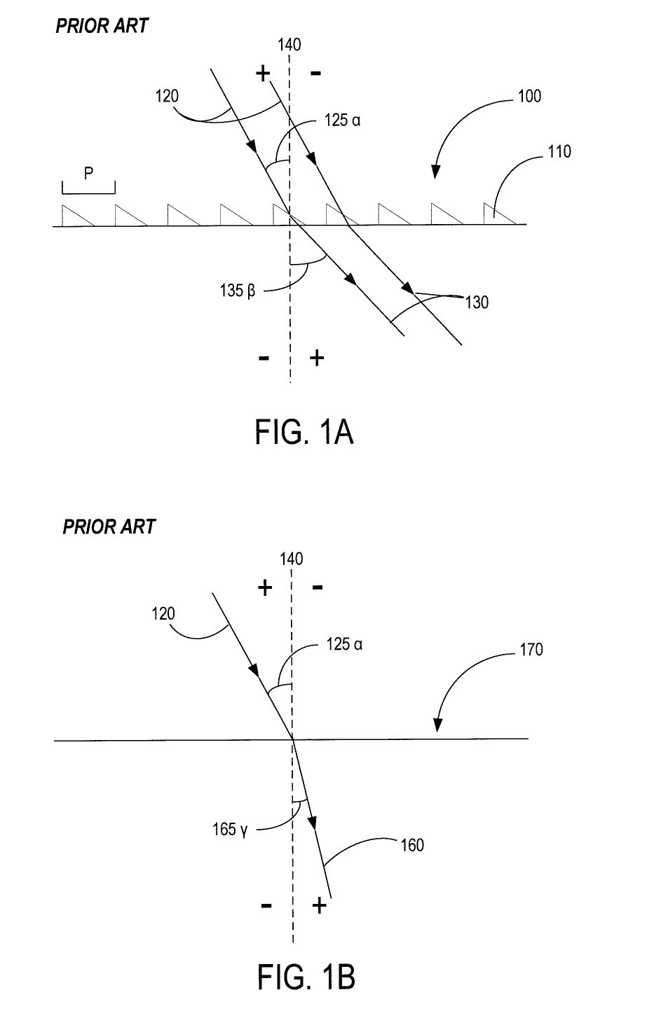

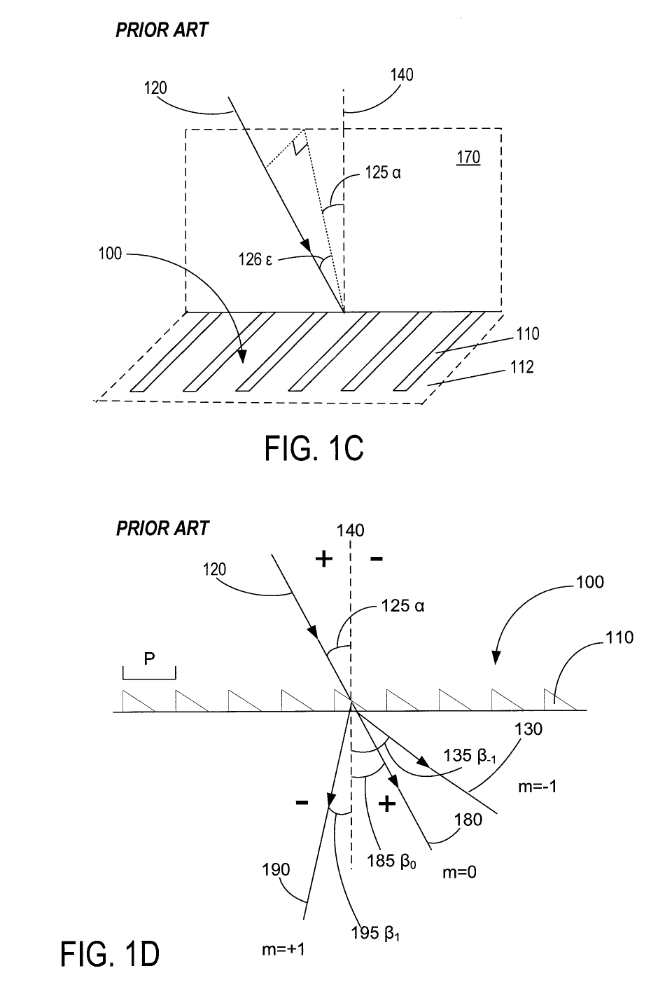

FIG. 1A is a cross sectional view of a diffraction grating 100 that includes grating elements 110 that are periodically spaced. The void between two adjacent grating elements 110 is called a groove. The distance P between the two adjacent grating elements 110 is called groove spacing, also termed the pitch. The paper perpendicularly cross-sections the grating elements 110 and the grooves. A normal line 140 is perpendicular to the surface of diffraction grating 100. Incident light 120 strikes diffraction grating 100 at an incident angle α (125), transmits through the grating surface, and is diffracted as diffracted light 130 at a diffraction angle β (135). While incident light must pass multiple grating elements for diffraction to occur, in many subsequent drawings only single rays are shown for simplicity.

FIG. 1B is a cross sectional view of a refraction system that does not include grating elements. Here, incident light 120 strikes a non-grated surface 170 at an incident angle α (125), transmits through the non-grated surface, and is refracted as refracted light 160 at a refraction angle γ (165). For example, one may observe that diffraction grating 100 (FIG. 1A) produces diffracted light 130 that bends outwardly away from normal line 140, whereas a non-grated refraction surface (FIG. 1B) may produce refracted light 160 that bends inwardly towards normal line 140 (depending on the refractive indices of materials on both sides of surface 170). This is in part evidenced by the observation that the diffraction angle β appears to be larger than the refraction angle γ in this example.

Referring to FIG. 1A, one may observe that both incident light 120 and diffracted light 130 are within the plane (i.e., the plane of the paper) that perpendicularly cross-sections grating elements 110 and the grooves. This type of grating system is called classical or in-plane diffraction. In contrast, FIG. 1C shows incident light 120 striking the surface 112 of diffraction grating 100 in a skewed fashion. Here, incident light 120 is not within the plane 170 that perpendicularly cross-sections grating elements 110 and the intervening grooves. Rather, incident light 120 strikes surface 112 at an angle ε (126). Further, the projection line of incident light 120 on surface 112 forms angle α (125) with normal line 140. This type of skewed, non-in-plane diffraction produces diffracted spectra as a cone, and is termed conical diffraction. The in-plane diffraction is a special case of a conical diffraction where ε=0.

A mathematical model for the general conical diffraction is the grating equation

mλ=(cos ε)P(sin α+sin β) Eq. 1.

For in-plane diffraction, since ε=0 and cos ε=1, the grating equation becomes:

mλ=P(sin α+sin β) Eq. 2

where λ is the incident light's wavelength, P is the pitch, α is the incident angle, β is the diffraction angle, and m is the diffraction order (or the spectral order), which is an integer.

For a given wavelength λ, several values of m correspond to various diffraction orders. FIG. 1D shows a cross sectional view of an in-plane diffraction with three orders, including m=0 producing a zero order diffracted light 180 with a diffraction angle β₀ (185), m=1 producing a positive first order diffracted light 190 with a diffraction angle β₁ (195), and m=−1 producing a negative first order diffracted light 130 with a diffraction angle β₋₁ (135).

The diffraction order m may be reduced by various means. For example, one may construct a grating in ways that effectively put all the diffracted light into a single, given grating order. One way to achieve this is to cut the grooves so that the grating element fits a particular profile, such as a triangle, including a right triangle.

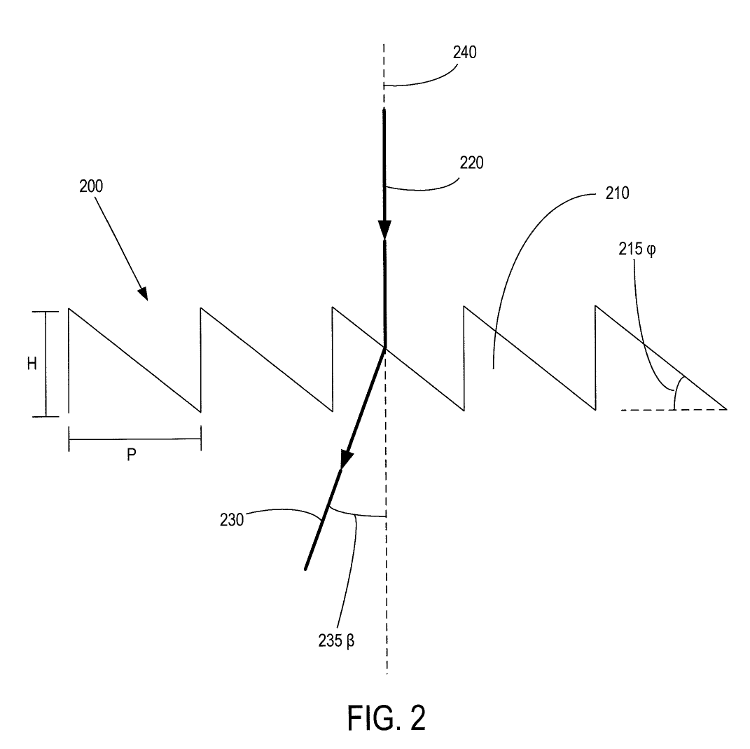

FIG. 2 illustrates an embodiment wherein the grooves are cut with an angle such that diffraction (as determined from the grating equation) and refraction as determined by the widely known Snell's law equation of Eq. 2a, (where n₁ and n₂ are indexes of refraction of the materials at the boundary, and θ₁ and θ₂ are the same, thereby effectively putting all diffracted light 230 into a single order.

$$\frac{sin {θ}_{1}}{sin {θ}_{2}} = \frac{{v}_{1}}{{v}_{2}} = \frac{{n}_{2}}{{n}_{1}} \qquad Eq . 2 a$$

FIG. 2 shows an example wherein incident light 220 overlaps with a normal line 240, resulting in an incident angle α=0. In addition, a diffraction grating 200 contains triangular grating elements 210, with a height H and a pitch P. A properly constructed blazed angle φ (215), along with an appropriate refractive index n of the grating material, work collectively to effectively put all diffracted light 230 into a single order, whose diffraction angle β (235) may be determined from the following equation:

sin β=n sin φ Eq. 3.

When α is not zero (not shown here), the proper blazed angle φ may be determined by simultaneously solving the grating equation and the Snell's law equation.

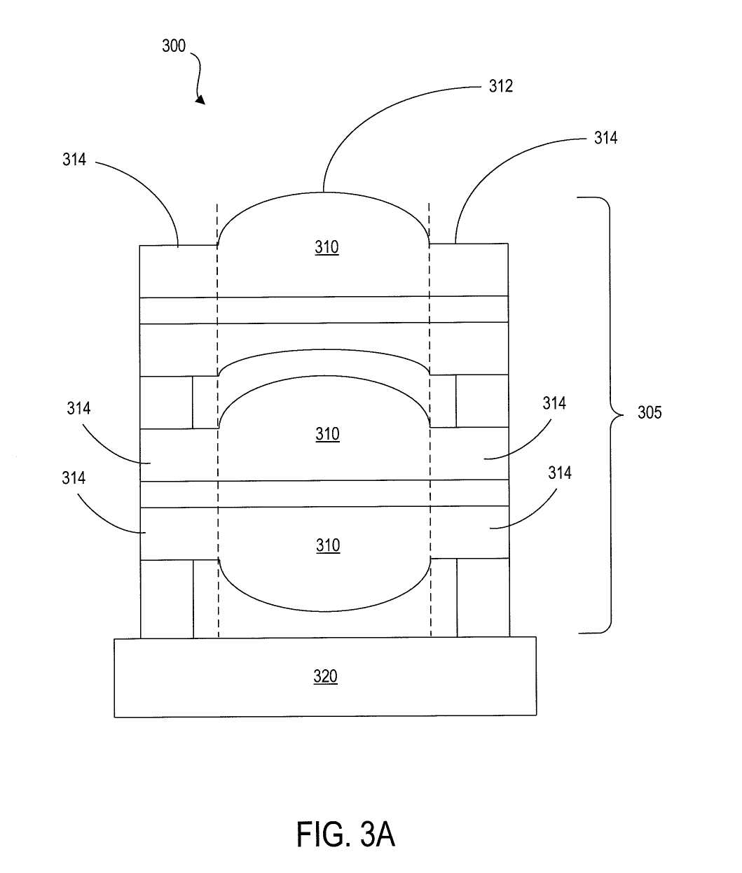

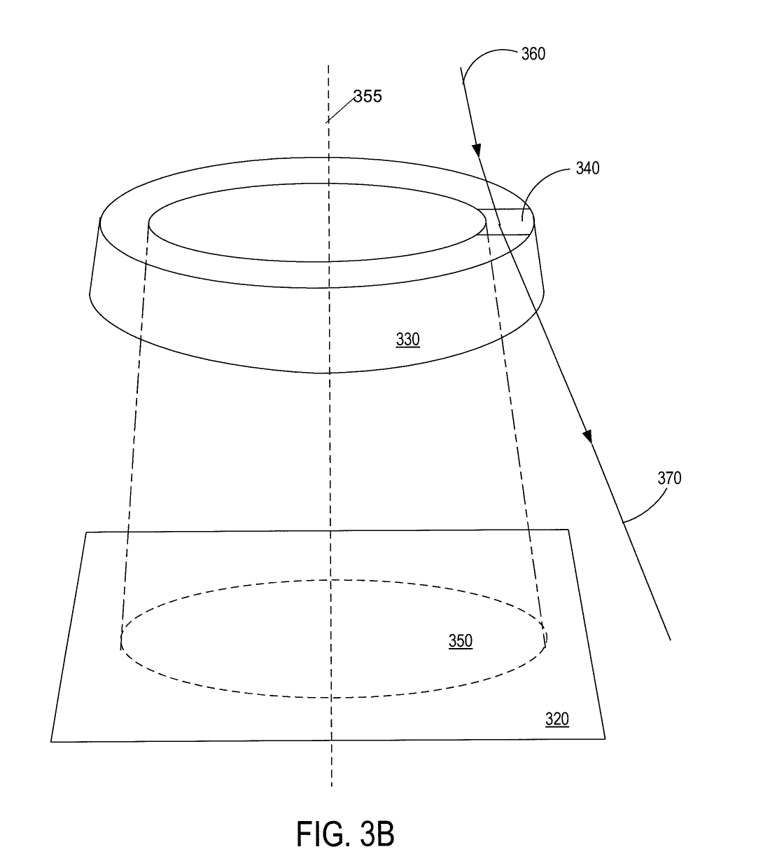

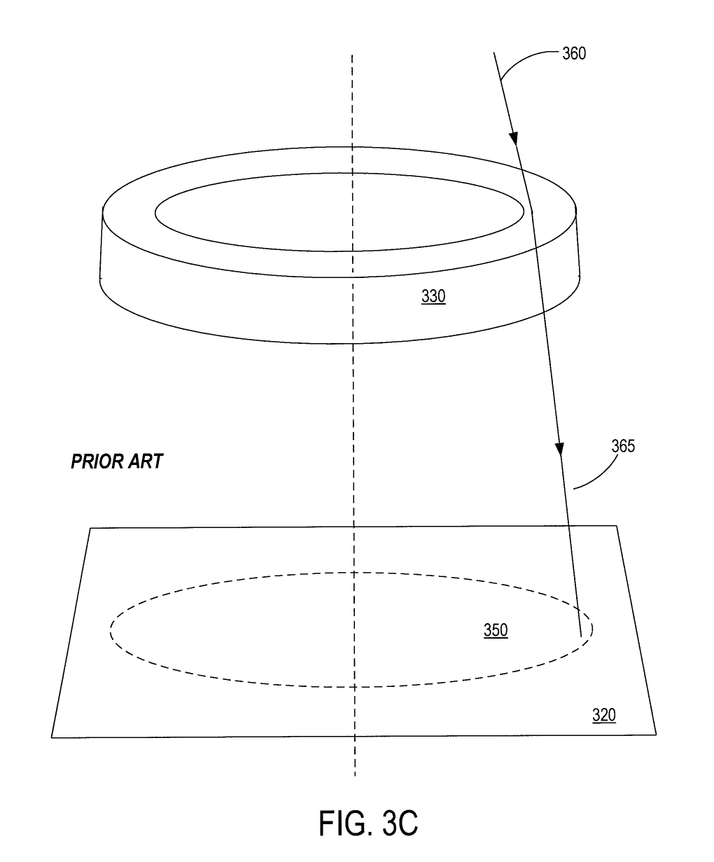

Transmission type diffraction, including reduced order diffraction, may be applied in the art of wafer level optics to improve image quality. One embodiment involves reducing stray light in the design of lenses such as monolithic lenses. FIG. 3A shows a schematic cross sectional view of a wafer level camera 300 that includes an opto-wafer element 305 positioned on top of an image sensor 320. Opto-wafer element 305 may include a lens 310, or several lenses 310 in a stack, as shown. Incident light may pass through a lens 310's central portion 312 to be focused onto underlying image sensor 320, to form a desired image. Incident light may also pass through a lens 310's outer perimeter, including one or more lens yards 314, and refract onto underlying image sensor 320. A “lens yard” herein refers to a peripheral portion of a lens that provides positioning and support for a central portion of a lens, but is not part of the optical design. In opto-wafer element 305, lens yards 314 are the portions of lenses 310 outside the vertical dashed lines, as shown. Stray light passing through one or more lens yards 314 may reduce image quality by causing effects such as flaring. To prevent stray light, a ring of black material, such as a black photoresist in the yard, may be applied onto lens yard 314, thereby forming an optical absorber to block incident light from passing through lens yard 314. However, in actual practice, such as in mass production, the black material may flake off, permitting light to leak through lens yard 314. An alternative approach to prevent stray light reaching image sensor 320 is to construct a grating type structure onto lens yard 314 to effectively diffract incoming light away to the side of the lens, thereby preventing the stray light from reaching underlying image sensor 320.

FIGS. 3B and 3C are perspective views that illustrate how a diffraction grating formed in lens yard 314 (FIG. 3A) prevents stray light from reaching image sensor 320. In both drawings, a lens yard structure 330 is positioned above a focal region 350. In FIG. 3C, lens yard 330 does not include a diffraction grating. Consequently, incident light 360 passes through lens yard 330, and is refracted inwardly as refracted light 365 that strikes within underlying focal region 350 of a focal plane. Focal region 350 lies on image sensor 320. This may produce flaring and reduce the wafer level camera's image quality. In FIG. 3B, lens yard 330 contains a diffraction grating 340, which may cover a portion or the entirety of lens yard 330. Incident light 360 that strikes diffraction grating 340 is diffracted away, for example as diffracted light 370, and misses underlying sensor focal region 350. By preventing stray light from reaching focal region 350, diffraction grating 340 reduces flaring from sources near an axis 355 of a lens system, and improves image quality of a wafer level camera incorporating lens yard 330 with grating 340.

Diffraction grating 340 may include a multitude of grooves. The orientation of these grooves may be of any direction that facilitates diffracting light away from focal region 350. For example, the grooves on lens yard 330 may be oriented radially outward from the lens center. In another example, the grooves on lens yard 330 may be oriented concentrically to the lens center.

Diffraction grating 340 may be constructed such that diffraction orders are reduced, for example, to effectively a single order, wherein this reduced or single order of diffracted light misses focal region 350. One way to achieve this is to cut the grooves so that the grating element fits a particular profile, such as a triangle, including a right triangle, with a properly constructed blazed angle φ. Along with an appropriate refractive index n of the grating material, the properly blazed grating element works to effectively put all the diffracted light into a single order that misses the focal plane (e.g., a plane including focal region 350). For example, a portion or the entirety of a lens yard (e.g., lens yard 330) may include a grating that has a groove density of approximately 800 grooves per millimeter, with the grooves positioned radially outward from the lens center. The grooves may be blazed to effectively put all the diffracted light into a single negative first order, with a being approximately zero degrees and c being approximately 48 degrees (see Eq. 1). The grating equation in its various forms (see above), along with other optics equations such as the Snell's law equation, may be used to design diffraction gratings that diffract stray light away from the focal plane. One skilled in the relevant art will recognize that the techniques described herein can be practiced without one or more of the specific details, or with other methods, components, materials, etc.

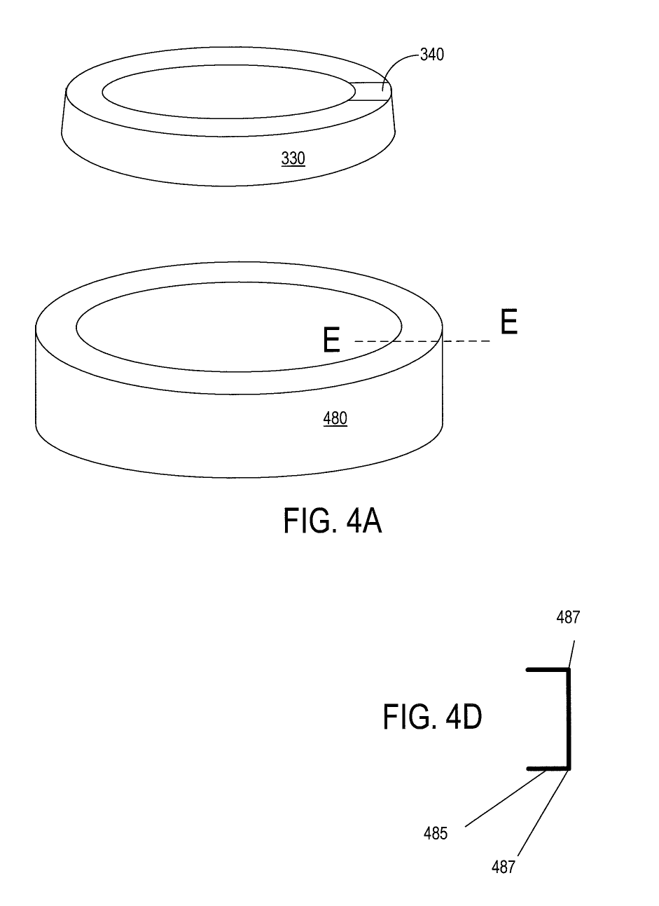

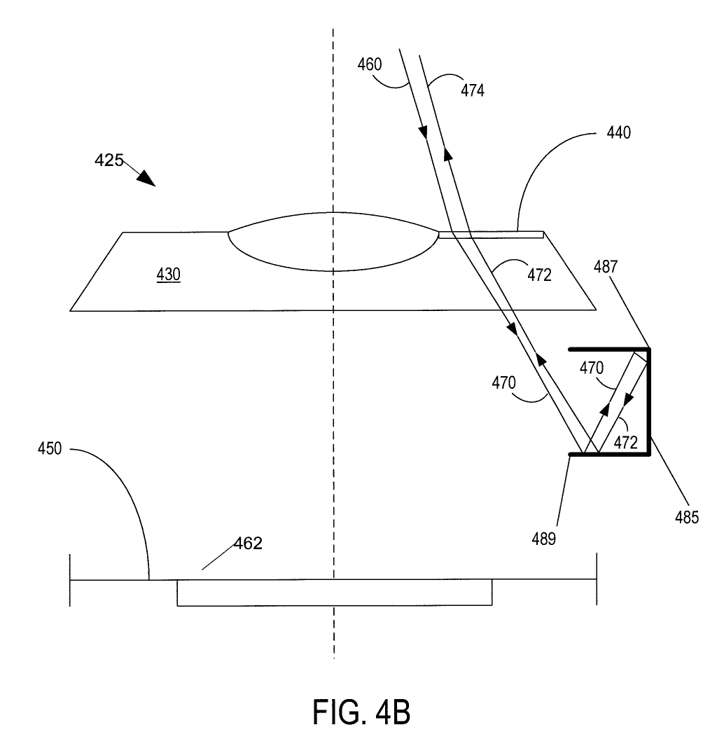

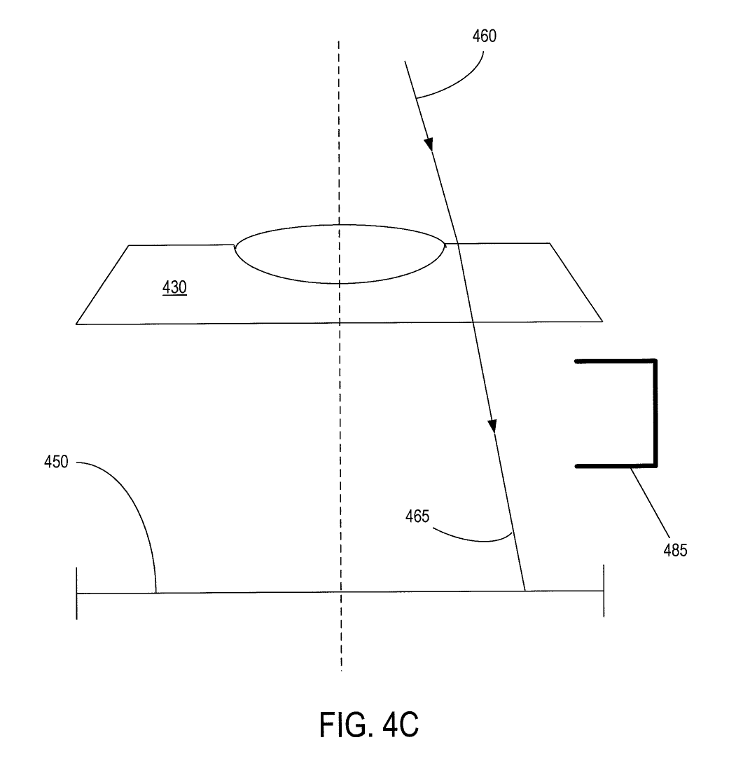

Additional structures may be added to work in concert with properly designed diffraction gratings to prevent stray light from reaching the focal plane. FIG. 4A is a perspective view of an embodiment that includes, in addition to lens yard 330 having a diffraction grating 340, an optical baffle 480 that is positioned beneath lens yard 330. Optical baffle 480 may be of a hollowed annulus configuration. An example of such configuration is referenced in FIGS. 4B-4D as 485, which is a cross sectional view of an optical baffle 480 that has an annular structure. Optical baffle 480 may include various surface treatments such as chrome or a carbon-black absorber. FIG. 4D is a cross section of an embodiment of optical baffle 480 taken along a plane including line E-E. It illustrates that optical baffle 485 is U-shaped in cross-section with two sharp, 90-degree corners 487. In an alternative embodiment an optical absorber is positioned similarly to optical baffle 480, such an absorber may be a cylinder of black.

FIG. 4B is a cross sectional view of an embodiment of an optical system 425 with an optical baffle 485 working in concert with a grated lens yard 430 to prevent stray light from reaching a focal plane 450. As incident light 460 strikes a diffraction grating 440 of lens yard 430, it is diffracted away as ray 470, which subsequently reaches optical baffle 485, and is reflected, absorbed, or otherwise diminished by optical baffle 485. In some embodiments, ray 470 is reflected by a lower portion 489 of optical baffle 485 into an upper corner 487 of optical baffle 485, where a ray 472 (now a reflected ray), is reflected again back to lower portion 489 and by lower portion 489 back into diffraction grating 440 of lens yard 430. After passage through diffraction grating 440, a ray 474 is now twice-diffracted, and exits optical system 425. As a result, stray light is prevented from reaching focal plane 450. Without diffraction grating 440 on lens yard 430, as shown in FIG. 4C, incident light 460 is refracted inwardly, resulting in refracted light 465 that misses optical baffle 485, and reaches focal plane 450, possibly producing flaring and reducing image quality.

In the embodiment of FIG. 4B, light arriving on the central part of the lens from an object focuses on an image sensor or photosensor array 462 located beneath the lens. The region where light from an object passing through the lens focuses on photosensor array 462 is a focal region, and lies on focal plane 450. Light arriving on the peripheral, lens-yard, portion of the lens from the same object or other objects in a field of view is diffracted away from, or diverted from, the photosensor array 462, and may be absorbed or reflected out of the optical system 425 by other optical components such as an optical baffle 485 or an absorber (not shown). Additional optical baffles and/or absorbers may also be present in a lens system, including one or more baffles between lenses of compound lens systems, and/or in front of lens. A baffle in front of lens 425 may, have many shapes, including a conic section of black absorptive material arranged to prevent at least some light arriving from outside the field of view from reaching lens 425 and being focused on photosensor array 462.

Diffraction gratings may be produced by various methods. For example, a ruled grating may be produced by using a ruling engine to cut grooves on a grating substrate. A ruled grating diffracts light efficiently but may include defects such as periodic errors, spacing errors and surface irregularities that can result in stray light and ghosting artifacts. In another example, a holographic grating may be produced by an optical technique of holographic recording.

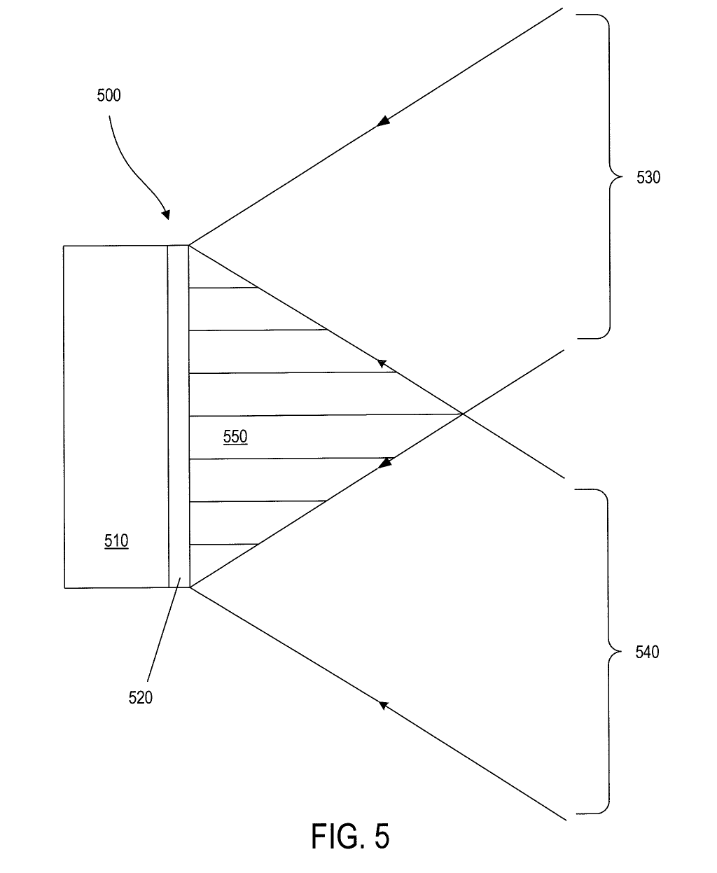

FIG. 5 is a cross sectional view of a holographic diffraction grating 500 manufactured by a photolithographic technique that utilizes a holographic interference pattern. Here, two intersecting light beams 530 and 540, such as laser beams, produce interference fringes 550, which may include equally spaced interference fringes. Interference fringes 550 are formed on a photoresist material 520 on a grating substrate 510. Photoresist material 520 dissolves in proportion to the intensity of interference fringes 550, resulting in holographic grating 500. A holographic grating typically has no periodic errors that may lead to stray light and ghosting effects, but may suffer from lower diffraction efficiency. In yet another example, holographic grating 500 may be additionally blazed to produce a blazed holographic grating.

A blazed grating is a grating having profiled ridges and/or grooves having a triangular or sawtooth profile. A blazed grating may be formed by techniques such as forming a holographic grating and altering its profile with reactive ion-beam etching. As an example, a holographic grating having a sinusoidal profile may be blazed and transformed into a saw tooth profile. Alternatively, a blazed grading may be formed by ruling a grating with a tool that cuts a groove having a triangular profile. A blazed holographic grating may offer a high diffraction efficiency that is similar to a blazed and ruled grating, but also maintains the effect of low stray light and low ghosting as a holographic sinusoidal grating.

Holographic recording may be produced by various additional means. One example is to use a photoresist material such as a 2-cyanoacrylate sheet containing p-benzoquinone, wherein a photochemical reaction results in a change in refractive index. Another example is to use a silver halide emulsion such as silver chloride or silver bromide, wherein procedures such as light exposure, developing, fixing and washing help to produce a holographic recording. Yet another example is to use a dichromated gelatin, wherein photonic decomposition photochemically crosslinks the gelatin and produces a difference in swelling. Yet another example is to use a photopolymer medium, wherein radiation, polymerization and monomer diffusion results in a refractive index modulation, thereby producing a holographic recording. Yet another example is to use a photochromic polymer such as a doped polymethyl methacrylate matrix, wherein a photonic stimulation results in a color change to produce a recording of an interference pattern. Yet another example is to use a photorefractive composition such as a carbazole-substituted polysiloxane derivative, wherein light alters refractive index to produce a recording of an interference pattern. Yet another example is to use a nanoparticle dispersion such as a zirconium oxide nanoparticle dispersed acrylate photopolymer film, wherein a redistribution of nanoparticles under holographic exposure results in compositional and density difference between bright and dark regions, such differences creating a refractive index grating. Yet another example is to use a photoactive liquid crystalline polymer such as an azobenzene-containing polymer, wherein a photo-initiated phase transition between a nematic state and an isotropic state modulates refraction index to produce a recording of a holographic interference pattern. Yet another example is to use a sol-gel matrix such as a tetraethoxy silane sol-gel glass, wherein photopolymerization or crosslinking produces a recording by modulating refractive index. Yet another example is to use polyelectrolytes as a holographic recording medium, wherein lithography techniques and heating produce a recording.

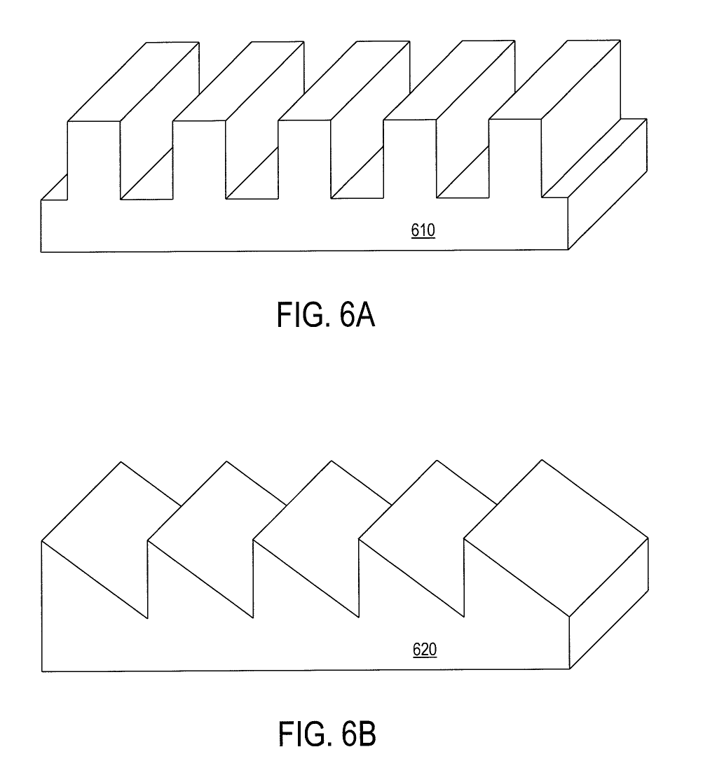

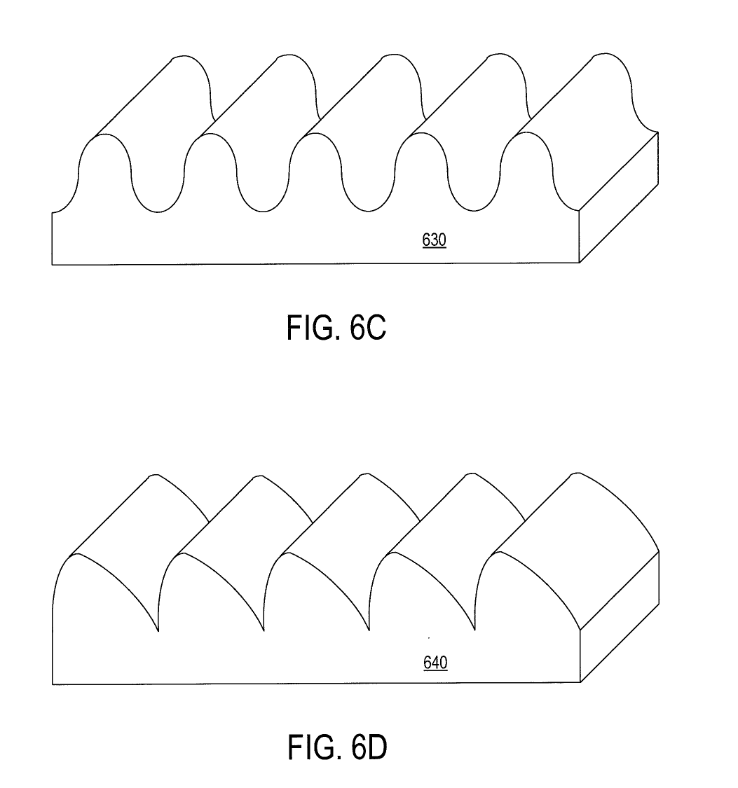

Diffraction gratings may be produced on surfaces with various curvature features including, for example, flat, concave, and convex features, or a combination thereof. Diffraction gratings may be constructed to include various configurations or profiles. For example, a diffraction grating may have a square profile 610 as shown in perspective view in FIG. 6A. In another example, a diffraction grating may have a blazed, triangular, saw tooth profile 620, as shown in FIG. 6B. Gratings having a triangular or sawtooth profile, including a type wherein the profile is a right triangle, are sometimes referred to as blazed gratings, and may be produced by a ruling engine that cuts grooves on a grating substrate. Blazed gratings diffract light efficiently but may include defects such as periodic errors, spacing errors and surface irregularities that can result in stray light and ghosting effects.

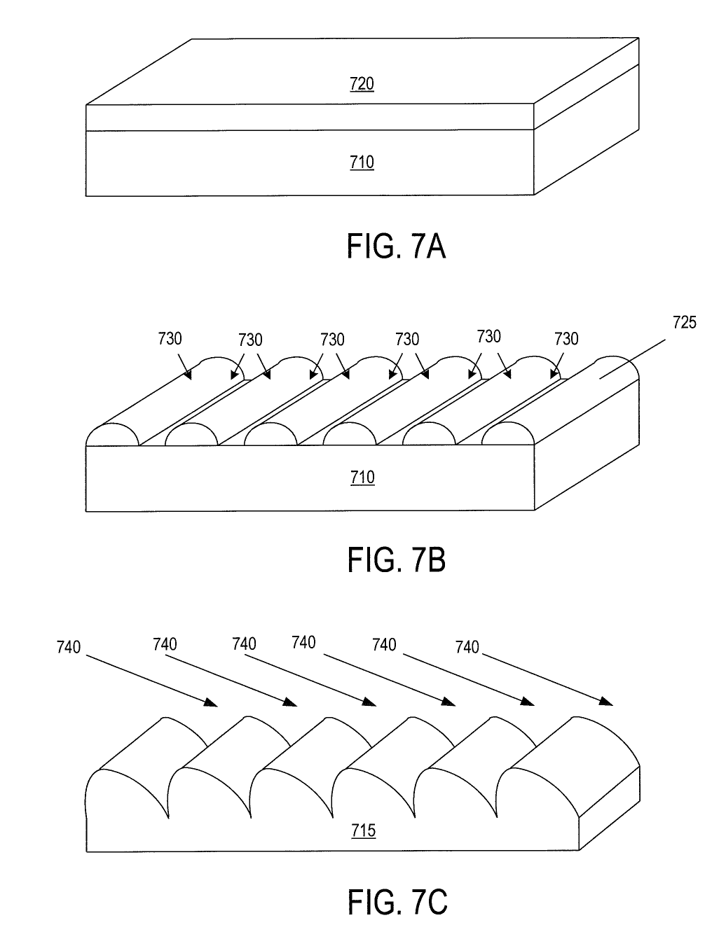

A diffraction grating may also have a sinusoidal profile 630, as shown in FIG. 6C. In another example, a diffraction grating may have a triangular, saw tooth profile 640 with relatively smooth edges, as shown in FIG. 6D. Gratings having triangular sawtooth profiles with smooth edges are sometimes referred to as blazed holographic gratings, and may be produced by methods that blaze a holographic grating, an example of which is described in the following paragraph and illustrated in FIGS. 7A, 7B and 7C. Blazed holographic gratings may offer high diffraction efficiency, similar to blazed ruled gratings, while maintaining the effects of low stray light and no ghosting achieved by holographic gratings.

FIG. 7A is a perspective view of a photoresist material 720 on top of a grating substrate 710. When photoresist material 720 is exposed to interfering laser beams 730, as shown in FIG. 7B, it dissolves in proportion to the intensity of the interference fringes, thereby producing a holographic grating profile 725. A subsequent etching process, such as a reactive ion etch 740, blazes the holographic grating to produce a blazed holographic grating 715, as shown in FIG. 7C. By way of example, blazed holographic grating 715 may include a saw tooth profile with relatively smooth edges.

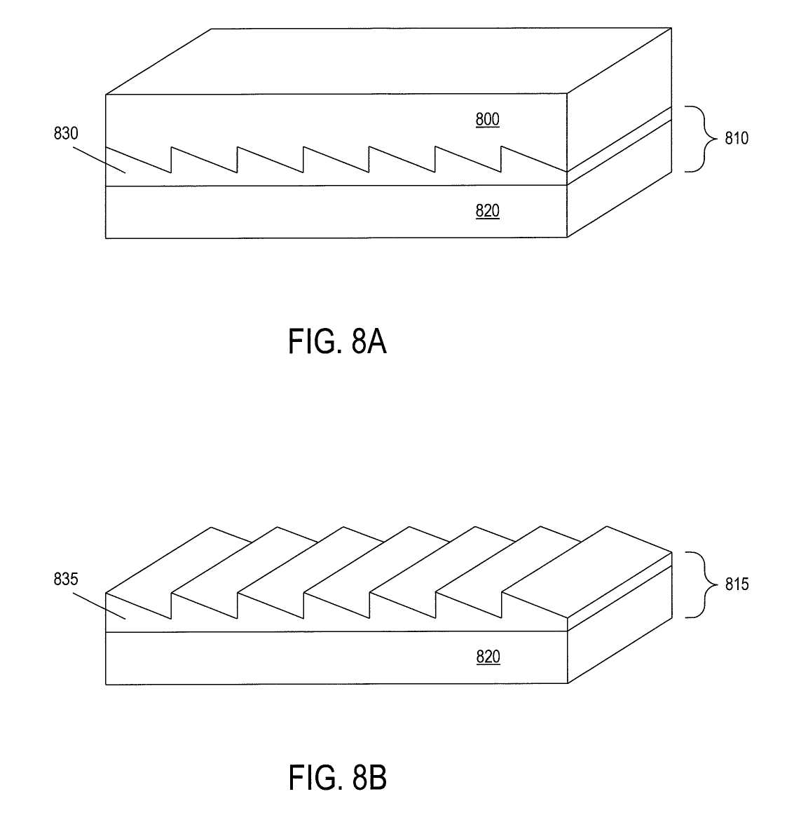

To reduce the cost of producing diffraction gratings, one may first produce a master grating by using techniques such as ruling, milling, holographic recording, reactive ion etching, and other processes, and then produce a multitude of less expensive replica gratings that are based on the master grating. Replica gratings may be made by techniques such as molding and stamping. An example of the replication techniques is illustrated by FIGS. 8A and 8B. First a master grating 800 having a saw tooth profile is produced by a technique such as ruling or photolithography. Then, an unmolded replica grating precursor 810 having a substrate 820 with at least a layer of deformable material 830 is pressed onto master grating 800, as shown in FIG. 8A. Examples of deformable material 830 include an ultraviolet light (“UV”) sensitive epoxy, which solidifies after being pressed to the master grating 800 followed by UV exposure, and a thermoplastic similar to that used for stamping compact discs, which is deformable when hot but hardens upon cooling. After parting, a molded replica grating 815 has a saw tooth profile 835 mirroring that of master grating 800, as shown in FIG. 8B.

Throughout this disclosure, a replica grating may be associated with similar terminology to that used to characterize the master grating that is used to produce the replica grating. For example, a replica grating produced from a blazed master grating may be called a blazed grating, even though a molding technique is used to produce this replica grating. In another example, a replica grating that is produced from a holographic master grating may often be called a holographic grating, even though a molding technique is used to produce this replica grating.

By employing various diffraction gratings and other embodiments as disclosed above, one may construct lenses of wafer level cameras such that stray light is substantially mitigated.

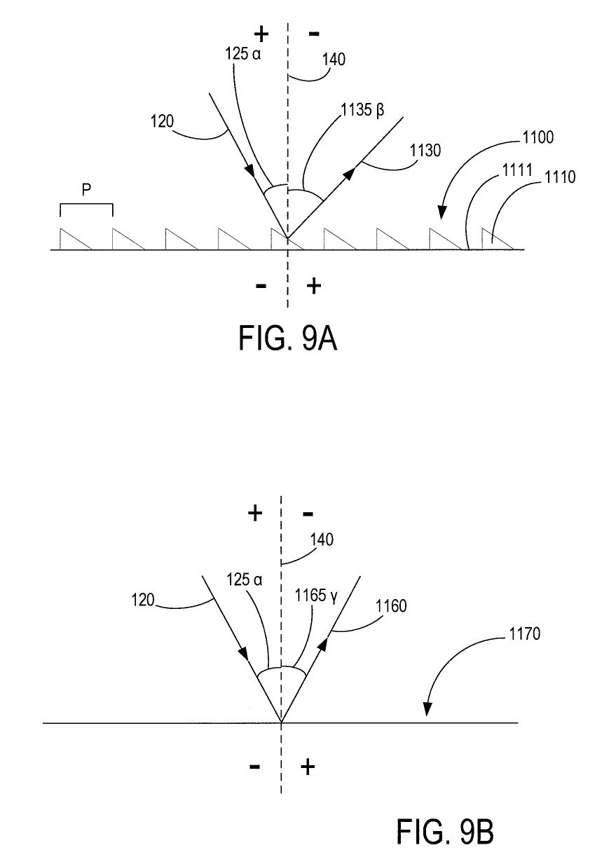

FIG. 9A is a cross sectional view of a reflective diffraction grating 1100 that includes periodically spaced grating elements 1110. The void between two adjacent grating elements 1110 is called a groove. The distance P between the two adjacent grating elements 1110 is called groove spacing, also called the pitch. FIG. 9A illustrates a perpendicular cross-section of grating elements 1110 and grooves 1111. A normal line 140 is perpendicular to the surface of diffraction grating 1100. Incident light 120 strikes diffraction grating 1100 at an incident angle α (125), reflects off the grating surface, and is diffracted as diffracted light 1130 at a diffraction angle β (1135).

FIG. 9B shows a cross sectional view of a reflection system that does not include grating elements. Here, incident light 120 strikes a non-grated surface 1170 at an incident angle α (125), reflects off non-grated surface 1170, and is reflected as reflected light 1160 at a reflection angle γ (165). The law of reflection suggests that incident angle α has the same absolute value as reflection angle γ. For example, diffraction grating 1100 may produce diffracted light 1130 that bends outwardly away from normal line 140, whereas a non-grated surface may produce reflected light 160 that bends inwardly towards normal line 140 (as compared with diffracted light 1130). In this example, diffraction angle β is larger than reflection angle γ.

A reflection type diffraction may have several diffraction orders, which may be reduced by various means. For example, one may construct a grating in ways that effectively put all the diffracted light into a single, given grating order. One way to achieve this is to construct the grooves (e.g., grooves 1111) so that the grating elements (e.g., elements 1110) fit a particular profile, such as a triangle with a properly constructed blazed angle that helps to effectively put all the diffracted light into a single order similar to FIG. 2 but in reflection mode.

To reduce the cost of producing diffraction gratings on lenses, one may first produce an fabrication master, which may be expensive, and then produce a multitude of inexpensive replicas based on the master, with the help of replication techniques such as molding. The master may be made of various materials including metal, polymer, glass, etc. The master may be grated by various techniques including ruling, holographic recording, photolithography, reactive ion etching, milling, etc. For example, a metal fabrication master may be subjected to a milling operation using a custom milling tool in order to generate gratings. Such a milling method may allow production of a grated master at reasonable cost, vis-à-vis conventional grating methods such as ruling and holographic recording. One example of a custom milling tool is a single flute, mono-crystalline diamond milling tool that includes specific geometry and cutting parameters, which produce desirable grating characteristics including a proper blazing angle, a proper grating pitch, and/or a proper grating height.

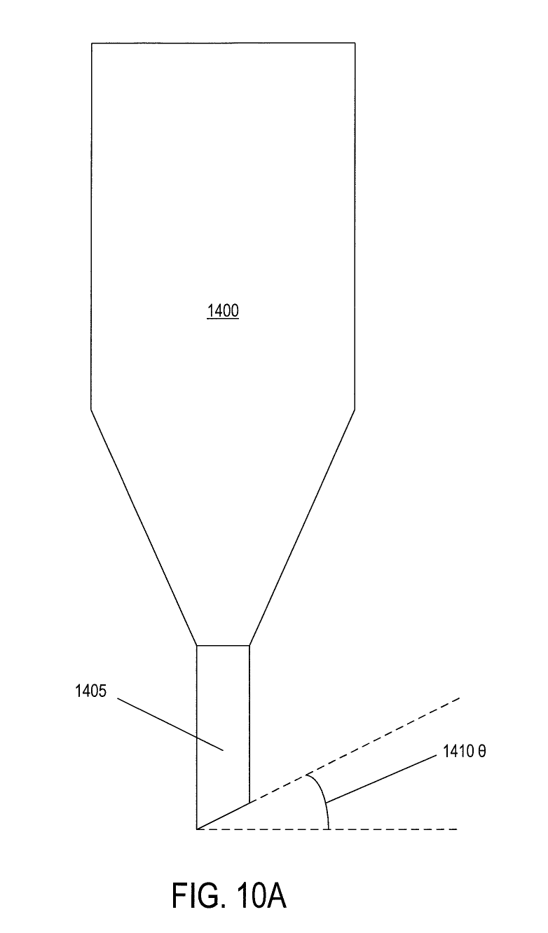

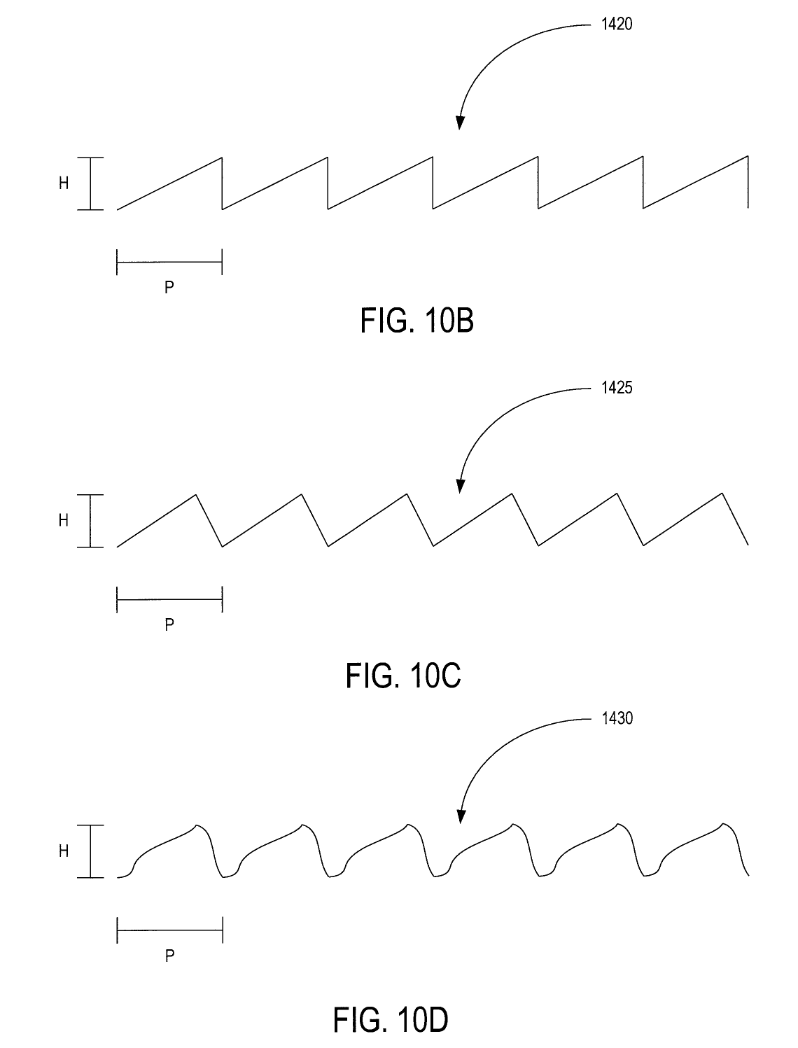

FIG. 10A is a cross sectional view of a custom milling tool 1400 that includes a single flute mono-crystalline diamond milling tip 1405. The profile of tip 1405 has a blazing angle θ (1410). Compared with a ruling engine, which may produce substantially straight and parallel grooves by using a reciprocal cutting motion, custom milling tool 1400 may produce substantially circular grooves by using a circular cutting motion that produces circular grooves, however the circular grooves are displaced from circle to circle. While the resulting grooves have spacing that varies with an offset along an axis perpendicular to the axis of displacement, portions of each circle form an arc, and the portions of the arc that are used in a particular grating may have sufficiently uniform spacing to perform predictable diffraction. The cross sectional profiles of milled gratings are substantially similar to those of ruled gratings. FIGS. 14B-14D show cross sectional profiles of several milled gratings, including a blazed, right triangular profile 1420 (FIG. 10B), an almost blazed, oblique triangular profile 1425 (FIG. 10C), and a relatively realistic, approximately triangular profile 1430 (FIG. 10D). In a milling operation, a desired grating pitch P may be generated by manipulating factors such as spindle speed and feed rate. Further, the grating height H may be determined by factors such as grating pitch P and blazing angle θ. For example, with a single flute milling tip, a spindle speed of 35,000 revolutions per minute and a feed rate of 87.5 millimeters per minute may produce a grating pitch of 2.5 micrometers. Further, a grating pitch of 2.5 micrometers and a blazing angle of 30 degrees may produce a grating height of 1.4 micrometers. In another example, a milling operation using a spindle speed of 35,000 revolutions per minute and a feed rate of 52.5 millimeters per minute may produce a pitch of 1.521 micrometers. Further, with a 30 degree blazing angle, the milling operation may produce a 0.83 micrometer height. In yet another example, a 0.936 micrometer pitch and a 32.89 degree blazing angle may produce a height of 0.591 micrometer.

In an alternative embodiment, an optical wafer has multiple lenses; each with a diffraction grating in the lens yard that is oriented to diffract light away from a focal zone on a photosensor array such as may be placed behind the lens. The optical wafer is produced by using a stamping mold having a mold for the lenses and for the diffraction grating. In an embodiment, the grating in the lens yard is a concentric grating having the same axis as the lens. In another embodiment, the grating in the lens yard is a radial grating from the center of the lens. The diffraction grating includes a replica of a grating selected from the group of a ruled grating, a blazed grating, a saw tooth grating, a holographic grating, a sinusoidal grating, a blazed holographic grating, a transmission grating, a reflection grating, and a milled grating.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various modifications are possible within the scope of the invention, as those skilled in the relevant art will recognize.

These modifications can be made to the invention in light of the above detailed description. The terms used in the following claims should not be construed to limit the invention to the specific embodiments disclosed in the specification. Rather, the scope of the invention is to be determined entirely by the following claims, which are to be construed in accordance with established doctrines of claim interpretation.

What is claimed is:

1. An optical system having a lens assembly for imaging an object, wherein the lens assembly comprises a lens wherein at least a portion of a peripheral part of the lens includes a diffraction grating arranged to divert light arriving on the peripheral part of the lens away from a focal region beneath the lens.

2. The optical system of claim 1, further including an image sensor disposed beneath the lens; the focal region on the image sensor; such that the central portion of the lens is capable of receiving light from an object and focusing that light on the image sensor.

3. The optical system of claim 2, further including at least one optical baffle between the lens and the focal region, wherein the diffraction grating is disposed to diffract at least some incident light into the optical baffle.

4. The optical system of claim 3, wherein the optical baffle reflects received light away from the focal region.

5. The optical system of claim 1, wherein the diffraction grating diffracts light into a reduced order.

6. The optical system of claim 1, wherein the diffraction grating diffracts light into a single order.

7. The optical system of claim 1, wherein the diffraction grating includes a replica of a grating selected from the group of a ruled grating, a blazed grating, a saw tooth grating, a holographic grating, a sinusoidal grating, a blazed holographic grating, a transmission grating, a reflection grating, and a milled grating.

8. The optical system of claim 1, wherein the diffraction grating includes grooves that are oriented radially from the center of the lens.

9. The optical system of claim 1, wherein the diffraction grating includes grooves that are oriented concentrically from the center of the lens.

10. The optical system of claim 8, the diffraction grating comprising a replica grating.

11. An optical system having a lens assembly, the lens assembly comprising a lens for focusing light arriving through a central portion of the lens onto a focal region, wherein at least a portion of a peripheral part of the lens includes a diffraction grating arranged to diffract at least some light arriving through the peripheral part of the lens away from the focal region.

12. A method of reducing stray light reaching an image sensor of a camera system, comprising:
Providing a lens, the lens having a lens portion and a lens yard portion;
Providing an image sensor, the lens disposed to focus on the image sensor;
Forming a diffraction grating on the lens yard portion, the lens yard portion arranged to diffract at least some stray light impinging on the lens yard portion away from the image sensor.

13. The method of claim 12 further comprising providing a baffle between the lens and the image sensor.

14. The method of claim 13 wherein the diffraction grating is an annular diffraction grating.

15. The method of claim 14 wherein the diffraction grating is a blazed annular diffraction grating.
